(19) United States
(12) Patent Application Publication
(10) Pub. No.: US 2023/0295053 A1
(43) Pub. Date: Sep. 21, 2023

(54) ITEM MADE OF CERAMIC

(71) Applicant: The Swatch Group Research and Development Ltd., Marin (CH)

(72) Inventors: Bernard BERTHEVILLE, Sion (CH); Yann FALLET, Savagnier (CH)

(73) Assignee: The Swatch Group Research and Development Ltd., Marin (CH)

(21) Appl. No.: 18/017,567

(22) PCT Filed: Jul. 28, 2021
(86) PCT No.: PCT/EP2021/071130

§ 371 Date: Jan. 23, 2023

(30) Foreign Application Priority Data
Sep. 25, 2020 (EP) 20198345.9

(51) Int. Cl. C04B 35/58; C04B 35/64

(52) U.S. Cl. CPC C04B 35/58021; C04B 35/64; C04B 2235/3856; C04B 2235/3847; C04B 2235/3244; C04B 2235/9661; C04B 2235/3891; C04B 2235/6567; C04B 2235/3217; C04B 2235/3886

(57) ABSTRACT

The invention relates to an item made of a material consisting of a plurality of ceramic phases, said material including:
a majority ceramic phase comprising nitrides and/or carbonitrides of one or more element(s) selected from among Ti, Zr, Hf, V, Nb, and Ta, said majority ceramic phase being present in a percentage by weight comprised between 60 and 98%,
at least one minority ceramic phase, with either one single minority ceramic phase formed of zirconium and/or aluminium silicide, or several minority ceramic phases formed respectively of carbides of one or more element(s) selected from among Ti, Zr, Hf, V, Nb, Ta, Cr, Mo and W and of zirconium oxides and/or aluminium oxides, said at least one minority ceramic phase being present in its entirety in a percentage by weight comprised between 2 and 40%.

The present invention also relates to the method for manufacturing this item.

### TECHNICAL FIELD

The present invention relates to an item and in particular to an external part or movement component in watchmaking, made of a composite material consisting solely of ceramic phases. It also relates to its manufacturing process.

### PRIOR ART

Many external part components are made of composite ceramic materials which have the advantage, inter alia, of having very high hardnesses which guarantee their ability not to be scratched. The literature mainly refers to composites consisting mainly of an oxide such as alumina to which carbides are added. It may, for example, consist of composites comprising by weight 70% of Al₂O₃ and 30% of TiC used as reinforcement. These composites have the characteristic of featuring little or no metallic brilliance compared to other materials such as stainless steels or ceramels, which might be a disadvantage for ornamental items where this brilliance is desired.

Materials based on titanium nitrides or carbonitrides are also known. These materials are extremely hard to densify due to their very high melting temperatures, for example 2,930° C. for TiN, associated with their low diffusion coefficients. Therefore, it is then necessary to resort to rapid sintering methods, also known as flash, such as SPS sintering (Spark Plasma Sintering) or pressure sintering methods (Sinter-HIP) or consolidation methods under very high pressures and high temperatures after sintering such as HIP (Hot Isostatic Pressure). In addition, these sintering processes do not allow obtaining parts with complex shapes. A way for solving this problem consists, for example to make ceramels based on TiN or TiCN, in adding a metallic element acting as a metallic binder. Thus, an addition of a few percents of nickel or cobalt allows consolidation at lower temperatures, typically in the range of 1,500° C. However, these elements have the disadvantage of being highly allergenic, thereby limiting use thereof to items that are not intended to be in contact with the skin.

### SUMMARY OF THE INVENTION

An object of the present invention is to overcome the aforementioned disadvantages by providing a ceramic material, also called composite, with a composition and a manufacturing process optimised to meet the following criteria:
avoiding the use of allergenic elements such as nickel or cobalt,
having a high metallic brilliance (65≤L*≤85),
being able to be densified under atmospheric pressure, under vacuum or under partial gas pressure without resorting to high pressures in order to preserve the shape of the blank of the item upon completion of sintering,
having a minimum hardness of 500 HV30, preferably a minimum of 800 HV30 and more preferably a minimum of 1,000 HV30 for applications requiring a very good scratch resistance, while having enough toughness with, preferably, a Kᵢc higher than or equal to 2.5 MPa.m^{1/2}.

To this end, the present invention provides an item made of a material consisting of several ceramic phases, said material including:
a majority ceramic phase comprising nitrides and/or carbonitrides of one or more element(s) from the IVB group, namely Ti, Zr and Hf, and/or from the VB group, namely V, Nb and Ta, said majority ceramic phase being present in a percentage by weight comprised between 60 and 98%,
at least one minority ceramic phase, with either a single minority ceramic phase formed of zirconium and/or aluminium silicide, or several minority ceramic phases formed respectively of carbides of one or more element(s) from the IVB group (Ti, Zr, Hf), the VB group (V, Nb, Ta) and the VIB group (Cr, Mo, W), and zirconium oxides and/or aluminium oxides, said at least one minority ceramic phase being present in its entirety in a percentage by weight comprised between 2 and 40%.

The composite material thus developed has, after polishing, a metallic brilliance similar to that one observed in stainless steels or ceramels using nickel or cobalt as a metallic binder. These composites have other advantages of being free of allergenic elements such as Ni. They also have high hardnesses and sufficient toughnesses for making external part components while being non-magnetic. Furthermore, they can be shaped by conventional powder metallurgy processes such as pressing or injection or by various processes dedicated to the manufacture of three-dimensional parts such as 3D printing in order to obtain “near-net shape” parts. Parts with more or less complex shape can be finally consolidated at temperatures comprised between 1,400 and 1,900° C. under atmospheric pressure, under vacuum or under partial gas pressure, i.e. without resorting to significant pressures.

Moreover, the items made of this ceramic material have the advantage of having a beautiful colour present in the mass with shades ranging from yellow to pink-red depending on the composition.

Other features and advantages of the present invention will appear in the following description of a preferred embodiment, presented as a non-limiting example with reference to the appended drawing.

### BRIEF DESCRIPTION OF THE FIGURE

FIG. 1 represents a timepiece comprising a middle made of the ceramic material according to the invention.

### DETAILED DESCRIPTION

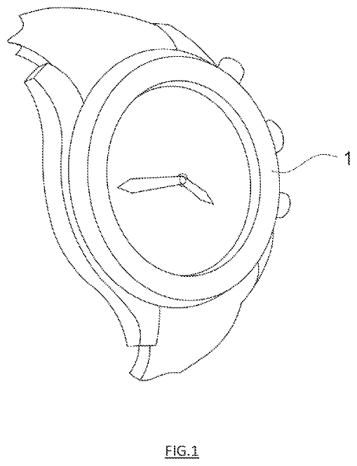

The present invention relates to an item made of a composite material consisting solely of ceramic phases. The item may be a decorative item such as a constituent element of watches, jewellery, wristlets, etc. or more generally an outer portion of a portable element such as a shell of a mobile phone. In the watchmaking field, this item may be an external part such as a middle, a bottom, a bezel, a crown, a bridge, a push-piece, a wristlet link, a dial, a hand, a dial index, etc. For illustration, a middle made with the ceramic material according to the invention is represented in FIG. 1. It may also consist of a component of the movement such as a plate or an oscillating mass.

The ceramic material includes a majority phase composed of nitrides and/or carbonitrides of one or more element(s) selected from among Ti, Zr, Hf, V, Nb and Ta, and one or more minority phase(s). These may be either zirconium and/or aluminium silicide, or a combination of carbides of one or more element(s) selected from among Ti, Zr, Hf, V, Nb, Ta, Cr, Mo and W and of zirconium (Zr) and/or aluminium (Al) oxides. Preferably, the majority phase is composed of titanium nitrides and/or titanium carbonitrides. Preferably, the minority phase(s) are respectively composed either of zirconium and/or aluminium silicide or a combination of tungsten and/or vanadium carbides and zirconium and/or aluminium oxides

The majority phase is present in a percentage by weight comprised between 60 and 98% and all of the minority phases are present in a percentage by weight comprised between 2 and 40%. Preferably, the majority phase is present in a percentage by weight comprised between 65 and 97%, more preferably between 70 and 96% by weight, and even more preferably between 75 and 95%. Complementarily to the majority phase, all of the minority phases are present in a percentage by weight preferably comprised between 3 and 35%, more preferably between 4 and 30% and even more preferably between 5 and 25%. When the majority phase comprises nitrides and carbonitrides of one or more element(s) selected from among Ti, Zr, Hf, V, Nb and Ta, the nitrides and carbonitrides are preferably present respectively in a percentage comprised between 20 and 70% by weight, more preferably between 25 and 60%, relative to the total weight of the ceramic material. When the ceramic material comprises two minority phases respectively of carbides of one element or several elements selected from among Ti, Zr, Hf, V, Nb, Ta, Cr, Mo and W and oxides (Al₂O₃ and/or ZrO₂), they are respectively and preferably present in a percentage comprised between 3 and 35% by weight, more preferably between 5 and 25%, relative to the total weight of the ceramic material.

The ceramic item is made by sintering starting from a mixture of powders. The manufacturing process includes steps of:
a) Making a mixture with the different ceramic powders, possibly in a wet environment. The starting powders preferably have a d50 smaller than 45 μm. Mixing can possibly be carried out in a grinder, which reduces the d50 of the particles of the powder to a size in the range of a few microns (<5 μm) after grinding. Powders of nitrides and/or carbonitrides of one or more element(s) selected from among Ti, Zr, Hf, V, Nb and Ta are present in a percentage by weight for all of these powders comprised between 60 and 98%, preferably between 65 and 97%, more preferably between 70 and 96% and even more preferably between 75 and 95%. Powders of zirconium silicide and/or aluminium silicide or powders of carbides of Ti, Zr, Hf, V, Nb, Ta, Cr, Mo and W and of zirconium and/or aluminium oxides are present in a percentage by weight comprised between 2 and 40%, preferably between 3 and 35%, more preferably between 4 and 30%, even more preferably between 5 and 25%. For example, the mixture of powders may include by weight one of the following distributions for a total of 100%:
   between 75 and 85% of TiN or TiCN and between 15 and 25% of ZrSi₂,
   between 85 and 95% of TiN or TiCN and between 5 and 15% of ZrSi₂,
   between 75 and 85% of TiN or TiCN, between 5 and 15% of WC or VC and between 5 and 15% of ZrO2 or Al2O3,
   between 40 and 55% of TiN, between 25 and 35% of TiCN, between 5 and 15% of WC or VC and between 5 and 15% ZrO2.
b) Optionally, a second mixture comprising the mixture cited above and an organic binder system (paraffin, polyethylene, etc.) can be made.
c) Forming a blank by conferring on the mixture the shape of the desired item, for example, by injection or pressing or by 3D printing.
d) Sintering the blank under partial gas pressure, under vacuum or under atmospheric pressure at a temperature comprised between 1,200 and 2,100° C., preferably between 1,400 and 1,900° C. for a period comprised between 10 minutes and 20 hours, preferably between 15 minutes and 3 hours. This step may be preceded by a debinding step in a temperature range comprised between 60 and 500° C. if the mixture includes a binder system. Although the compositions according to the invention allow sintering under low pressure, the present invention does not exclude sintering being carried out by SPS (Spark Plasma Sintering) or by sinter-HIP, followed or not by HIP (Hot Isostatic Pressure) consolidation.

The blank thus obtained is cooled and polished. It may also be machined before polishing to obtain the desired item.

The item resulting from the manufacturing method includes the majority phase and the minority phase(s) in percentages by weight close to those of the starting powders. However, small variations in compositions and percentages between the base powders and the material resulting from sintering cannot be excluded following, for example, contamination or transformations during sintering. For example, the carbides could react with the nitrides to form carbonitrides.

The item has a CIELAB colour space (in compliance with the standards CIE No. 15, ISO 7724/1, DIN 5033 Teil 7, ASTM E-1164) with a luminance component L*, representative of the manner in which the material reflects light, comprised between 60 and 85 and, preferably, between 65 and 80, and more preferably between 70 and 75. Advantageously, the item is yellow coloured and has an a* component (red component) comprised between +1 and +7 and a b* component (yellow component) comprised between +20 and +35. Advantageously, the item is pink-red coloured and has an a* component comprised between +2 and +15 and a b* component comprised between +2 and +10.

The ceramic material has a HV30 hardness higher than or equal to 500, preferably comprised between 800 and 1,800 depending on the types and percentages of the constituents. It has a toughness Kᵢc higher than or equal to 2 and preferably higher than or equal to 2.5 MPa.m^{1/2} with values that can range up to 8 MPa.m^{1/2}, the toughness being determined on the basis of the measurements of the lengths of the cracks at the four ends of the diagonals of the hardness indentation according to the formula:

$${K}_{1 C} = 0.0319 \frac{P}{a {l}^{1 / 2}}$$

where P is the load applied (N), a is the half-diagonal (m) and l is the measured crack length (m).

The examples hereinafter illustrate the method according to the invention and the material resulting therefrom.

7 powder mixtures were prepared in a mill in the presence of a solvent. The mixtures were produced without binder. They have been shaped by pressing and sintered either under vacuum or under a flow of argon or nitrogen at 60 mbar, at a temperature which depends on the composition of the powders. After sintering, the samples have been polished. Table 1 hereinafter includes the compositions, the sintering parameters and the mechanical properties (HV30, Ki_{c}) as well as the Lab colourimetric values.

The values in italics and bold meet the criteria for a hardness higher than 800 Vickers, a toughness higher than 2.5 MPa.m1/2, a L* index higher than 70 or a b* index higher than 20 for a very yellow colour.

HV₃₀ hardness measurements were made on the surface of the samples and the tenacity was determined based on the hardness measurements as described above.

The Lab colorimetric values were measured on the polished samples with a KONICA MINOLTA CM-5 spectrophotometer under the following conditions: SCI (specular component included) and SCE (specular component excluded) measurements, inclination of 8°, 8 mm diameter MAV measurement zone.

### Example 1

It consists of a ceramic composite including titanium nitride (TiN) as the majority phase and zirconium silicide (ZrSi₂) as the minority phase up to 20% by weight. According to the invention and in comparison with conventional sintering, this composite has been densified by Spark Plasma Sintering (SPS). The measured hardness is 1,328 Vickers (HV30) and the toughness 4.3 MPa.m^{1/2}.

### Example 2

It consists of a ceramic composite including titanium nitride (TiN) as the majority phase and zirconium silicide (ZrSi₂) as the minority phase up to 10% by weight. This 90TiN—10ZrSi₂ composite has been densified by both SPS and conventional sintering. When it is sintered by conventional sintering, a drop in hardness is observed compared to SPS sintering, falling from 1,302 to 863 Vickers but keeping good toughness (4.2 versus 4.4 MPa.m^{1/2}). On the other hand, by conventional sintering, a much better brilliance is obtained with a higher luminance index (L*) (74.5 versus 66.2). Conventional sintering also allows obtaining a more yellow tint with a slightly higher value of the yellow component b*.

### Example 3

It consists of a ceramic composite including titanium carbonitride (TiCN) as the majority phase and zirconium silicide (ZrSi₂) as the minority phase up to 10% by weight. This 90TiCN—10ZrSi₂ composite has a lower hardness of 590 Vickers but features the most marked yellow colouration with a b* value reaching 27.29.

### Example 4

It consists of a ceramic composite based on titanium nitride (TiN) as the majority phase, and with tungsten carbides (WC) and aluminium oxide (Al₂O₃c) as minority phases, according to the proportions by weight 80TiN—10WC—10Al₂O₃. Such a composite, densified by conventional sintering and without pressure input, has a hardness of 938 Vickers, a toughness of 3.6 MPam^{1/2} and a strong yellow colour with values of 1.7 for a* and 26.2 for b* while keeping a beautiful metallic brilliance (L*=72.8).

### Example 5

It consists of a ceramic composite based on titanium nitride (TiN) as the majority phase and with tungsten carbide (WC) and zirconium dioxide (ZrO₂) as minority phases, according to the proportions by weight 80TiN—10WC—10ZrO₂. This composite has a maximum hardness of 1,187 Vickers and a measured luminance L* of 72.9. The colour of such a ceramic composite is yellow, with values of the indexes a* and b* of 1.48 and 26.0 respectively. Hence, replacing aluminium oxide (Example 4) with zirconium dioxide allows increasing the hardness by 249 Vickers.

### Example 6

It consists of a ceramic composite based on titanium nitride (TiN) as the majority phase and with vanadium carbide (VC) and zirconium dioxide (ZrO₂) as minority phases, according to the proportions by weight 80TiN—10VC —10ZrO₂. This composite has a hardness of 1,275 Vickers and a measured luminance L* of 71.8. The colour of such a ceramic composite is yellow, with values of a* and b* of 2.9 and 23.4 respectively. Hence, replacing tungsten carbide (Example 5) with vanadium carbide allows increasing the hardness by about 7%.

### Example 7

It consists of a ceramic composite including titanium nitride (TiN) and titanium carbonitride (TiCN) as the majority phase, and tungsten carbide (WC) and zirconium dioxide (ZrO₂) as minority phases, according to the proportions by weight 48TiN—32TiCN—10WC—10ZrO₂. Such a composite has a pink-red colour with indexes a* and b* of values 7.52 and 8.02 respectively. The measured hardness is very high, i.e. 1,727 Vickers, and almost identical to that one obtained by SPS sintering. This increase results directly from the addition of tungsten carbide.

TABLE 1

| | | | | Sintering | | | Properties | | | | |
|---|---|---|---|---|---|---|---|---|---|---|---|
| | Composition (wt) | | | | | time | | K1C | | | |
| No. | Nitride | Carbide | Oxide/Silicide | Furnace | T (° C.) | (min) | HV30 | (MPa · m ½) | L* | a* | b* |
| (1) | 80% TiN | / | 20% ZrSi2 | SPS | 1,400 | 15 | 1,328 | 4.3 | 65.5 | 6.45 | 22.36 |
| (2) | 90% TiN | / | 10% ZrSi2 | Normal | 1,450 | 90 | 657 | 3.6 | 75.0 | 3.39 | 24.33 |
| | | | | Normal | 1,500 | 90 | 701 | 2.8 | 73.1 | 3.07 | 23.92 |
| | | | | Normal | 1,600 | 90 | 863 | 4.2 | 74.5 | 1.17 | 25.31 |
| | | | | SPS | 1,500 | 15 | 1,302 | 4.4 | 66.2 | 6.18 | 23.59 |
| (3) | 90% TiCN | / | 10% ZrSi2 | Normal | 1,600 | 90 | 590 | 4.9 | 69.3 | 2.07 | 27.29 |
| (4) | 80% TiN | 10% WC | 10% Al203 | Normal | 1,650 | 90 | 938 | 3.6 | 72.8 | 1.71 | 26.22 |
| | | | | Normal | 1,700 | 75 | 1,002 | 2.2 | 70.9 | 1.46 | 25.81 |
| (5) | 80% TiN | 10% WC | 10% ZrO2 | Normal | 1,600 | 90 | 1,050 | 4.2 | 72.4 | 1.59 | 25.66 |
| | | | | Normal | 1,650 | 90 | 1,187 | 3.6 | 72.9 | 1.48 | 26.00 |
| (6) | 80% TiN | 10% VC | 10% ZrO2 | Normal | 1,650 | 30 | 1,050 | 2.3 | 70.1 | 3.13 | 22.74 |
| | | | | Normal | 1,750 | 30 | 1,275 | 2.8 | 71.8 | 2.94 | 23.42 |
| (7) | 48% TiN - | 10% WC | 10% ZrO2 | Normal | 1,650 | 45 | 1,727 | 2.4 | 64.5 | 7.17 | 7.58 |
| | 32% TiCN | | | Normal | 1,725 | 45 | 1,721 | 2.7 | 64.1 | 7.52 | 8.02 |

1. An item made of a material comprising several ceramic phases, said material including:
a majority ceramic phase comprising nitrides and/or carbonitrides of one or more element(s) selected from among Ti, Zr, Hf, V, Nb, and Ta, said majority ceramic phase being present in a percentage by weight comprised between 60 and 98%,
a single minority ceramic phase formed of zirconium and/or aluminium silicide, said minority ceramic phase being present in its entirety in a percentage by weight comprised between 2 and 40%.

2. The item according to claim 1, wherein the majority ceramic phase is present in a percentage by weight comprised between 65 and 97% and in that said minority ceramic phase is present in its entirety in a percentage by weight comprised between 3 and 35%.

3. The item according to claim 1, wherein the majority ceramic phase is present in a percentage by weight comprised between 70 and 96% and in that said minority ceramic phase is present in its entirety in a percentage by weight comprised between 4 and 30%.

4. The item according to claim 1, wherein the majority ceramic phase is present in a percentage by weight comprised between 75 and 95% and in that said minority ceramic phase is present in its entirety in a percentage by weight comprised between 5 and 25%.

5. The item according to claim 1, wherein when the majority ceramic phase comprises nitrides and carbonitrides of one or more element(s) selected from among Ti, Zr, Hf, V, Nb and Ta, said nitrides and carbonitrides are present respectively in a percentage comprised between 20 and 70% by weight relative to the total weight of the ceramic material.

6. The item according to claim 5, wherein said nitrides and carbonitrides are present respectively in a percentage comprised between 25 and 60% by weight relative to the total weight of the ceramic material.

7. The item according to claim 1, wherein the majority ceramic phase comprises titanium nitrides and/or titanium carbonitrides.

8. The item according to claim 1, wherein it has, in a CIELAB colourimetric space, a L* component comprised between 60 and 85 and, preferably, between 65 and 80.

9. The item according to claim 1, wherein it is yellow coloured and has, in a CIELAB colour space, an a* component comprised between +1 and +7 and a b* component comprised between +20 and +35.

10. The item according to claim 1, wherein it is pink-red coloured and has, in a CIELAB colourimetric space, an a* component comprised between +2 and +15 and a b* component comprised between +2 and +10.

11. The item according to claim 1, wherein it has a HV30 hardness higher than or equal to 500.

12. The item according to claim 1, wherein it has a HV30 hardness comprised between 800 and 1,800.

13. The item according to claim 1, wherein it has a toughness Kic higher than or equal to 2 and preferably higher than or equal to 2.5 MPa.m1/2.

14. The item according to claim 1, wherein the material includes for a total of 100% one of the following distributions:
a majority ceramic phase comprising between 75 and 85% of TiN or TiCN and a minority ceramic phase comprising between 15 and 25% of ZrSi2,
a majority ceramic phase comprising between 85 and 95% of TiN or TiCN and a minority ceramic phase comprising between 5 and 15% of ZrSi2,

15. The item according to claim 1, wherein it consists of a horological component.

16. The item according to claim 15, wherein it is an external part component selected from the list including a middle, a bottom, a bezel, a push-piece, a crown, a wristlet link, a dial, a hand and a dial index or a component of the movement selected from the list including a plate, a bridge and an oscillating mass.

17. A method for manufacturing an item comprising the successive steps consisting in:
a) making a mixture comprising a powder of nitrides and/or carbonitrides of one or more element(s) selected from among Ti, Zr, Hf, V, Nb and Ta, in a percentage by weight comprised between 60 and 98% and comprising at least one powder:
either formed of zirconium and/or aluminium silicide,
said at least one powder being present in its entirety in a percentage by weight comprised between 2 and 40%,
b) forming a blank by conferring on said mixture the shape of the item,
c) sintering the blank at a temperature comprised between 1,200 and 2,100° C., preferably between 1,400 and 1,900° C., for a period comprised between 30 minutes and 20 hours, preferably between 15 minutes and 3 hours.

18. The manufacturing method according to claim 17, wherein the mixture of powders from step a) includes, for a total of 100%, one of the following distributions:
between 75 and 85% of TiN or TiCN and between 15 and 25% of ZrSi2, between 85 and 95% of TiN or TiCN and between 5 and 15% of ZrSi2,
